(19) United States
(12) Patent Application Publication
(10) Pub. No.: US 2011/0161127 A1
(43) Pub. Date: Jun. 30, 2011

(54) Method and System for Providing Site Recovery Information

(76) Inventors: Sheilah Lakay Hunter Stripling, Mableton, GA (US); David G. Doyle, Campbell, CA (US); Jewell D. Holden, Dallas, GA (US); Laurens Paul McCarty, San Jose, CA (US)

(21) Appl. No.: 12/648,899

(22) Filed: Dec. 29, 2009

(51) Int. Cl. G06F 15/173; G06Q 10/00; G06Q 50/00; G06Q 99/00; G06F 15/16

(52) U.S. Cl. 705/7.13; 705/345; 709/217; 709/224

(57) ABSTRACT

A computer readable storage medium stores a set of instructions executable by a processor. The instructions are operable to receive, from a plurality of sources, data relating to a plurality of problems in a network; categorize the data according to a plurality of criteria, the criteria relating to the plurality of problems; and generate a subset of the categorized data.

### BACKGROUND

During large-scale outages, communications network providers may deploy field workers to repair various network components. In the course of a single large-scale outage, an individual field worker may travel to a number of different equipment sites and perform a different type of maintenance work at each equipment site. Information about equipment sites and outages should be provided to workers in the field in order that repairs may be completed efficiently.

### SUMMARY OF THE INVENTION

A computer readable storage medium stores a set of instructions executable by a processor. The instructions are operable to receive, from a plurality of sources, data relating to a plurality of problems in a network; categorize the data according to a plurality of criteria, the criteria relating to the plurality of problems; and generate a subset of the categorized data.

A system includes a plurality of data sources and a data server. The data server receives data from the plurality of data sources. The data server categorizes the data according to a plurality of criteria. The criteria relating to the plurality of problems. The data server transmits a subset of the categorized data to a user.

A system includes means for receiving data from a plurality of sources. The data relates to a plurality of outages in a communications network. The system also includes means for categorizing the data according to a plurality of criteria. The criteria relate to the plurality of outages. The system also includes means for providing a subset of the categorized data to a user.

### BRIEF DESCRIPTION OF THE DRAWINGS

FIG. 1 shows a system for providing data to workers according to an exemplary embodiment.

FIG. 2 shows a method for providing data to workers according to an exemplary embodiment.

FIG. 3 shows an exemplary display of data to a user according to an exemplary embodiment.

FIG. 4 shows a further exemplary display of data to a user according to an exemplary embodiment.

### DETAILED DESCRIPTION

The exemplary embodiments may be further understood with reference to the following description and the appended drawings, wherein like elements are referred to with the same reference numerals. The exemplary embodiments describe systems and methods for providing data to workers located remotely.

During large-scale outages, such as natural disasters, communications network providers may deploy field workers to repair various network components. During a single large-scale outage, a field worker may travel to a number of different equipment sites and perform maintenance work at each equipment site. Information about equipment sites and outages should be provided to workers in the field in order that repairs may be completed efficiently.

In order for field workers to perform their assigned tasks efficiently and expediently, network providers may wish to minimize the need for such workers to research, document and report the status of network elements being serviced during such an outage. By making such information available both to field workers and network administrators efficiently, network services may be restored as quickly as possible. This may also lead to improvements in public safety, as public utilities such as light towers and 911 telephone services may be restored correspondingly quickly.

Information that may be required in order for such restoration to be possible may include the location of outages, both geographically and in virtual terms. Geographical location of outages may include city, county, state, market or region. Outages may also be classified by a manager of the affected area. Outages may be time stamped so that those existing before a selected time may be separated from those created after the selected time. Information may also include resources, such as portable generators, allocated to address a given outage.

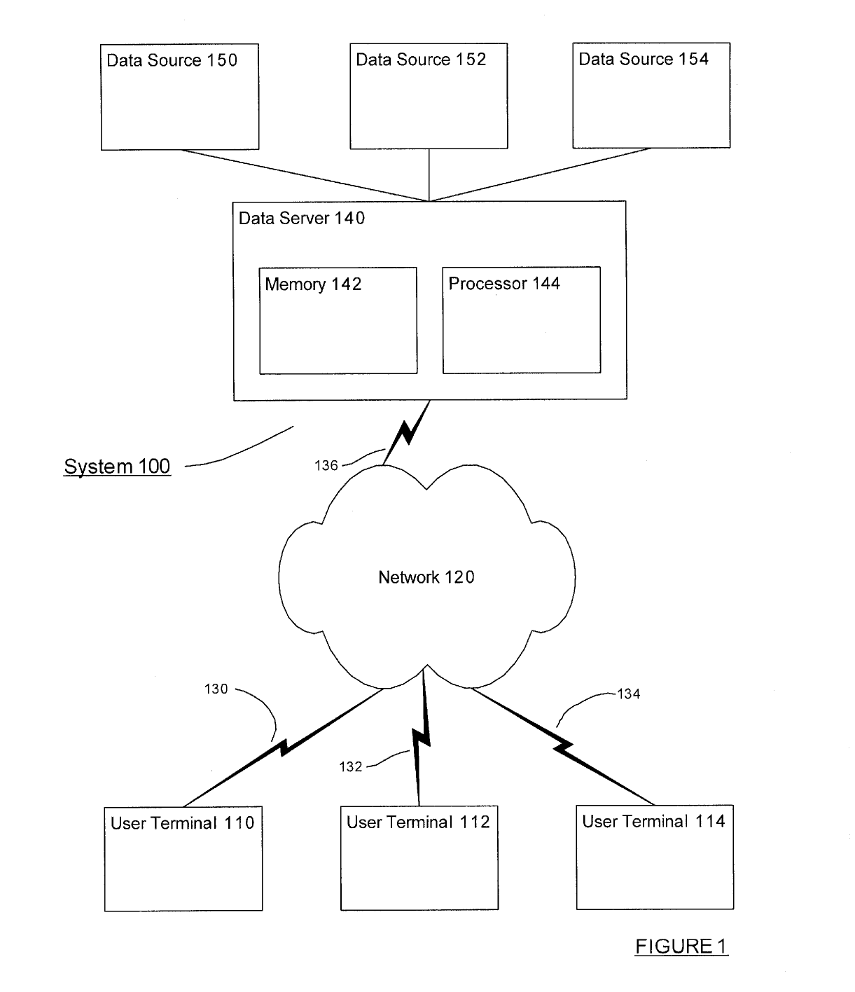

FIG. 1 illustrates an exemplary system 100 for providing data relating to problems in a network. Problems may include outages, as discussed above, or any other issue with respect to network equipment. The system may be accessed by users through a plurality of user terminals 110, 112 and 114. Those of skill in the art will understand that the number of user terminals may vary among differing implementations. User terminals 110, 112 and 114 may be any equipment that is capable of providing data to the user in accordance with the exemplary embodiments; the user terminals 110, 112 and 114 may each include memory and a processor, which, for clarity, are not shown in FIG. 1. This may include a mobile phone, a smart phone, a mobile computer, a palmtop computer, a notebook computer, a computing system integrated with a vehicle, etc. Those of skill in the art will understand that the terminals 110, 112 and 114 may include similar or differing hardware and software.

The user terminals 110, 112 and 114 may communicate with a network 120 via communication links 130, 132 and 134, respectively. The network 120 may be, for example, a communications network, the Internet, a proprietary network, an intranet, etc. The communication links 130, 132 and 134 may be any type of link that is appropriate for the nature of the corresponding user terminals 110, 112 and 114, and of the network 120, such as a cellular network connection, a local area network (“LAN”) connection, a wide area network (“WAN”) connection, a personal area network (“PAN”) connection, a wired connection to the network 120, etc. Those of skill in the art will understand that the communication links 130, 132 and 134 may be similar or may differ depending on the nature of the user terminals 110, 112 and 114.

Through the network 120, the user terminals 110, 112 and 114 may receive information from a data server 140, which may be a dedicated server for providing data in accordance with the exemplary embodiments, or may perform various other tasks in addition to those described herein. The data server 140 includes memory 142 and a processor 144. The data server 140 may connect to the network via communication link 136. The data server 140 may, in turn, receive data from a plurality of sources 150, 152 and 154 via communication links 160, 162 and 164 respectively. The sources 150, 152 and 154 may be any source that may provide the type of data described above. This may include a service ticketing system, a communications network switching system, a commercial or proprietary system for providing map data, or a user such as an administrator manually entering data. As above, the nature of the communication links 160, 162 and 164 may vary appropriately depending on the nature of their corresponding sources 150, 152 and 154.

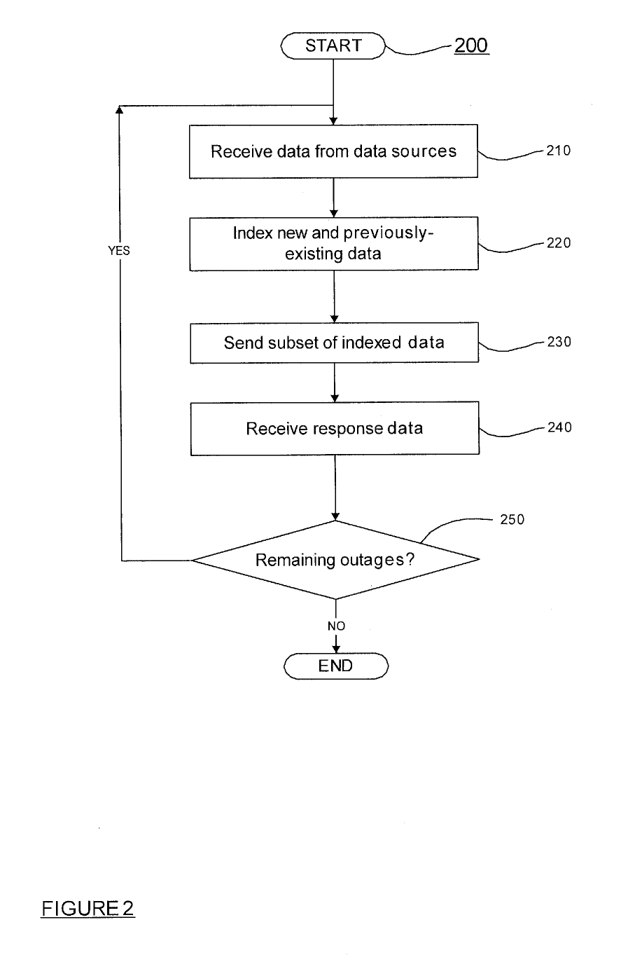

FIG. 2 illustrates an exemplary method 200 by which the system 100 of FIG. 1 may operate. In step 210, the data server 140 receives data from the sources 150, 152 and 154. This may be accomplished by the data server 140 requesting data (e.g., at set time intervals, by being prompted by a user interacting directly with the data server 140, in response to a request from one of the user terminals 110, 112, 114, etc.) or may be accomplished by one or more of the sources 150, 152 or 154 pushing new data to the data server 140.

In step 220, the data server 140 indexes data, including both newly-received data and data previously existing in the data server 140. Indexing may classify data based on, for example, a geographical location (e.g., a street address, GPS coordinates, a region, etc.) of related network hardware, a virtual location (e.g., an IP address or other network location identifier) of related network hardware, an amount of time for which the related network hardware has been malfunctioning, a manufacturer of the network hardware, a type of the malfunction, a field worker who has been assigned to repair the network hardware, an identifier of equipment (e.g., a serial number of a portable generator) that has been allocated to use in repairing the network hardware, etc.

In step 230, the data server 140 sends a subset of the indexed data to a field worker. The sending of data may be initiated by a request by the user, in response to an instruction by a network administrator, or in accordance with a mechanism for automatically sending such data to field workers. For example, data relating to a particular outage may be automatically sent to a selected one of a group of field workers based on the selected worker's current geographical proximity to the outage, based on the selected worker's technical expertise in an area relating to the outage, etc. Data to be sent may include, for example, a location of an outage to be repaired by the worker, directions from the worker's present location to the location of the outage (e.g., by determining the worker's present location using a GPS integrated into the user terminal), the nature of the outage to be repaired, or other pertinent information relating to the outage.

In step 240, the data server 140 receives information from the field worker about an attempt to repair the outage (e.g., whether the repair was successful or unsuccessful; if unsuccessful, the nature of the failure, etc.). Subsequently, in step 250, the data server 140 determines whether there are remaining outages to be repaired. If so, the method returns to step 210, where the data received includes that received in step 240, and the data server 140 continues to update as described above. If no outages remain, the method terminates after step 250. Those of skill in the art will understand that while the exemplary method 200 describes a method for providing data to field workers, data may be provided to network administrators in substantially the same manner.

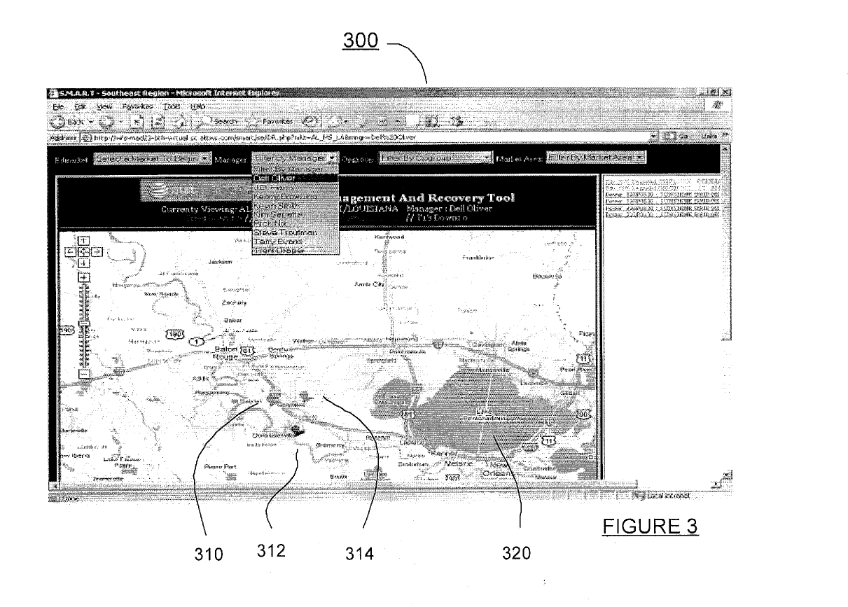

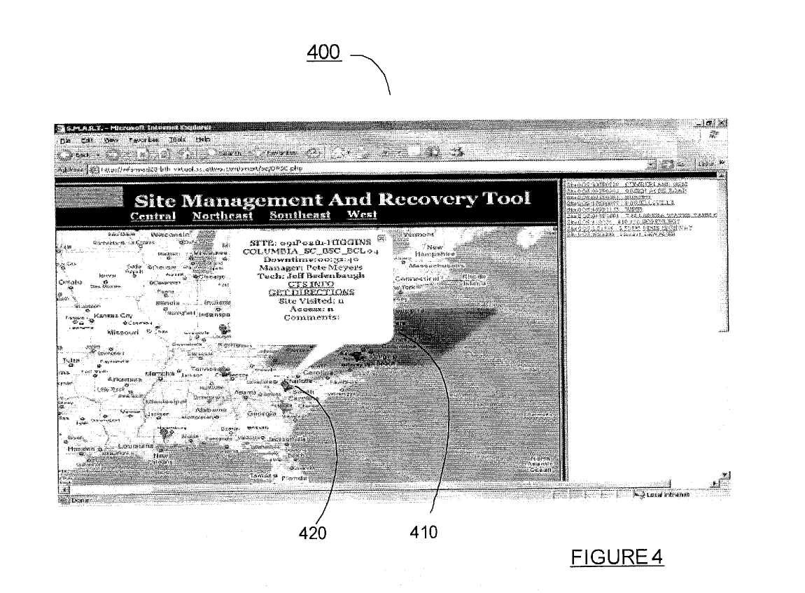

FIG. 3 illustrates an exemplary view 300 providing data according to the exemplary embodiments described above. The view 300 includes the locations of three outages 310, 312 and 314 shown on a map 320. FIG. 4 illustrates a further exemplary view 400 providing information 410 about a selected outage 420. Selecting an outage from a map view represents one exemplary way by which the data server 140 may be prompted to send data in step 230 as described above.

The exemplary embodiments described above may provide data about outages in a communications network to both network administrators and field workers in a simple, efficient manner. Data provided may be selected to be appropriate for the needs of the individual to whom the data is being provided. By providing data in accordance with these exemplary embodiments, mass outages may be repaired more quickly, thereby enhancing both network performance and customer experience.

The exemplary embodiments have been described above with reference to communications networks. However, those of skill in the art will understand that the broader principles may be equally applicable to any type of network. This may include, but is not limited to, communications networks, electric networks, television/cable networks, fiber optic networks, pipeline networks, water networks, etc.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A computer readable storage medium storing a set of instructions executable by a processor, the instructions being operable to:
receive, from a plurality of sources, data relating to a plurality of problems in a network;
categorize the data according to a plurality of criteria, the criteria relating to the plurality of problems; and
generate a subset of the categorized data.

2. The computer readable storage medium of claim 1, wherein the data relate to a plurality of sites requiring maintenance.

3. The computer readable storage medium of claim 1, wherein the subset relates to a selected one of the problems to be repaired by a user.

4. The computer readable storage medium of claim 1, wherein the subset is provided to a user via a mobile computing device.

5. The computer readable storage medium of claim 1, wherein the subset is provided to a user in response to one of a request by the user and an instruction by a network administrator.

6. The computer readable storage medium of claim 3, wherein the instructions are further operable to:
receive, from the user, further data relating to an attempt to repair the selected one of the problems; and
update the categorized data in accordance with the further data.

7. The computer readable storage medium of claim 3, wherein the data relates to equipment allocated to repair the selected one of the problems.

8. The computer readable storage medium of claim 7, wherein the equipment is a portable electrical generator.

9. The computer readable storage medium of claim 1, wherein the user is one of a field worker and a network administrator.

10. The computer readable storage medium of claim 1, wherein the plurality of sources includes one of a service ticketing system, a communications network switching system, a system for providing map data, and a manual entry of data.

11. A system, comprising:
a plurality of data sources; and
a data server receiving data from the plurality of data sources, the data server further categorizing the data according to a plurality of criteria, the criteria relating to the plurality of problems, the data server further transmitting a subset of the categorized data to a user.

12. The system of claim 11, wherein the data relate to a plurality of sites requiring maintenance.

13. The system of claim 11, wherein the subset relates to a selected one of the problems to be repaired by the user.

14. The system of claim 11, wherein the subset is provided to the user via a mobile computing device.

15. The system of claim 11, wherein the subset is provided to the user in response to one of a request by the user and an instruction by a network administrator.

16. The system of claim 13, wherein the data server receives, from the user, further data relating to an attempt to repair the selected one of the problems, and wherein the data server updates the categorized data in accordance with the further data.

17. The system of claim 13, wherein the data relates to equipment allocated to repair the selected one of the problems.

18. The system of claim 17, wherein the equipment is a portable electrical generator.

19. The system of claim 11, wherein the plurality of sources includes one of a service ticketing system, a communications network switching system, a system for providing map data, and a manual entry of data.

20. A system, comprising:
means for receiving, from a plurality of sources, data relating to a plurality of outages in a communications network;
means for categorizing the data according to a plurality of criteria, the criteria relating to the plurality of outages; and
means for providing a subset of the categorized data to a user.
